(19) United States
(12) Patent Application Publication
(10) Pub. No.: US 2006/0049709 A1
(43) Pub. Date: Mar. 9, 2006

(54) Brushless direct current motor with chamfered magnet

(75) Inventor: Heung Gyun Noh, Gwangju (KR)

Correspondence Address: LADAS & PARRY, 26 WEST 61ST STREET, NEW YORK, NY, 10023, US

(73) Assignee: SAMSUNG GWANGJU ELECTRONICS CO., LTD.

(21) Appl. No.: 10/989,247

(22) Filed: Nov. 15, 2004

(30) Foreign Application Priority Data
Sep. 9, 2004 (KR) P2004-71993

(51) Int. Cl. H02K 1/27

(52) U.S. Cl. 310/156.38; 310/156.28; 310/271

(57) ABSTRACT

A brushless DC motor with improved configuration of magnets attached to a rotor thereof. The brushless direct current motor includes a stator having coils for inducting magnetic flux according to applied electric current, and a rotor installed in the stator, and including a core in which a rotating shaft is connected to, and magnets attached around the core. Each of the magnets has chamfered portions at sides of the respective magnets.

### CROSS-REFERENCE TO RELATED APPLICATION

This application claims the benefit of Korean Patent Application No. 2004-71993, filed on Sep. 9, 2004, in the Korean Intellectual Property Office, the disclosure of which is incorporated herein by reference.

### BACKGROUND OF THE INVENTION

1. Field of the Invention

The present invention relates to a brushless direct current motor, and more particularly to configuration of magnets attached to a rotor of a brushless direct current motor.

2. Description of the Related Art

Brushless direct current (DC) motors have been developed to overcome disadvantages of conventional DC motors using brushes due to the mechanical contact of a commutator with the brush, and are motors in which the commutating device is replaced with a magnetic polarity sensor and a semiconductor switch. The present invention particularly relates to a sensorless brushless DC motor, and relates to a brushless DC motor for detecting the position of a rotor using respective counter electromotive forces without using the magnetic polarity sensor.

The conventional sensorless brushless DC motor, as shown in FIG. 1, includes a stator 1 and a rotor 2.

The rotor 2 is installed inside the stator 1, and in order to install the rotor 2, the stator 1 is formed with a space for installing the rotor 2 at the central portion thereof. The stator 1 is provided with teeth 1a extended to the central portion of the stator 1 and arranged in the radial direction, and is formed with slots 1b between adjacent teeth 1a, so that coils are wound around the teeth 1b.

The rotor 2 is spaced apart from the teeth 1a of the stator 1 by a predetermined gap. The rotor 2 includes a rotor core 2a, disposed at the central portion thereof, in which a rotating shaft is installed, magnets 2b are arranged on the outer circumferential surface of the core 2a in the circumferential direction such that their polarities are alternately arranged, and a scatter preventing can 2c for prevent the magnets 2b from being separated from the core 2a when the rotor 2 is rotated. When the magnet 2b is attached to the outer circumference of the core 2a such a magnet is referred to as a surface mounted permanent magnet (SPM).

In the conventional sensorless brushless DC motor, when the electric power is supplied to the coils of the stator 1, electromagnetic interaction between the coils and the magnets 2b serves to rotate the rotor 2. At that time, the voltage supplied to the stator 1 is electrically controlled by detecting the position of the rotor 2 based on the phase counter electromotive forces present at terminals of the coils of the stator 1.

In more detail, if a driving signal is applied, the rotator 2 is arranged by supplying electric power to two phases of the stator 1 so as to position the rotor 2 at a predetermined position. After that, if the motor is driven to rotate for a predetermined time and the motor exceeds predetermined RPMs, voltage is inducted to the coils of the stator so as to generate counter electromotive forces. Then, the position of the rotor 2 is estimated based on the generated phase counter electromotive forces, so that the driving signal can be generated and sensorless operation of the motor enabled.

However, in a four-polarity six-slot SPM concentrated winding type brushless DC motor different from the conventional distributed winding type brushless DC motor having many slots, as shown in FIG. 2, a waveform of flat counter electromotive force appears at the zero crossing point (Vdc/2). This waveform makes detection of the position of the rotor 2 unstable and makes the phase changing point irregular, so that abnormal electric current as shown in FIG. 3 is generated. Due to this, compressors adopting the brushless DC motor are deteriorated and fluctuate when sucking and discharging.

Moreover, the strong magnetic field and the unbalanced strong magnetic flux generated at corners of the magnets due to the magnetized windings deteriorate cogging torque characteristics and exert negative effects on the operational characteristics. Since a comparator must be added to a control board in order to realize perfect control of a motor when the counter electromotive force is detected earlier than the position detecting time by avoiding the flat interval of the waveform, cost of materials is increased.

### SUMMARY OF THE INVENTION

The present invention has been made in view of the above-mentioned problems, and an aspect of the invention is to provide a four-polarity six-slot sensorless brushless DC motor in which the position of a rotor is easily detected by linearizing waveforms of respective phase counter electromotive forces at respective coil terminals of a stator at a zero-crossing point.

In accordance with one aspect, the present invention provides a brushless direct current motor including a stator having coils for inducting magnetic flux according to applied electric current, and a rotor installed in the stator, and having a core in which a rotating shaft is connected to and magnets attached around the core, wherein each of the magnets has chamfered portions at sides of the respective magnets.

Preferably, the chamfered portions are formed at the outer sides of the magnets.

Moreover, the circumferential length of respective chamfered portions is approximately 22 to 33% of the overall circumferential length of the respective magnets.

An angle of respective chamfered portions with respect to the center of the rotor is approximately 20 to 30 degrees.

A radial length of respective chamfered portions is approximately 50 to 63% of the overall radial length of the respective magnets.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a plan view illustrating a conventional brushless DC motor;

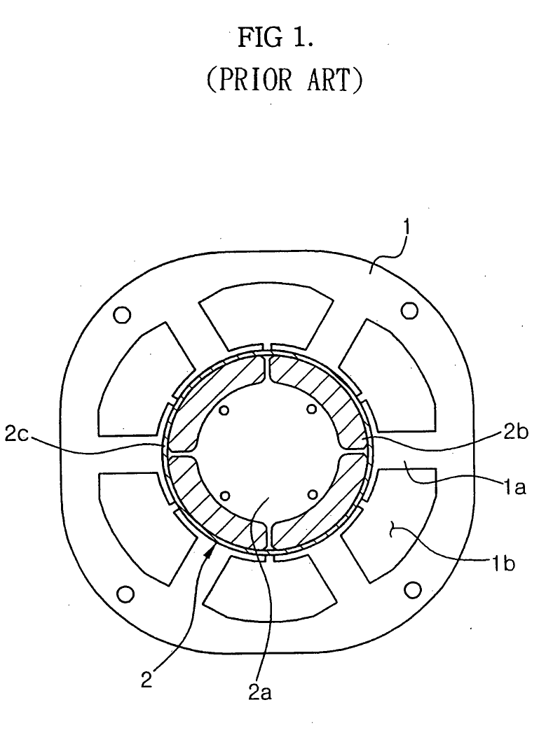

FIG. 2 is a graph illustrating a waveform of the counter electromotive force in the conventional brushless DC motor;

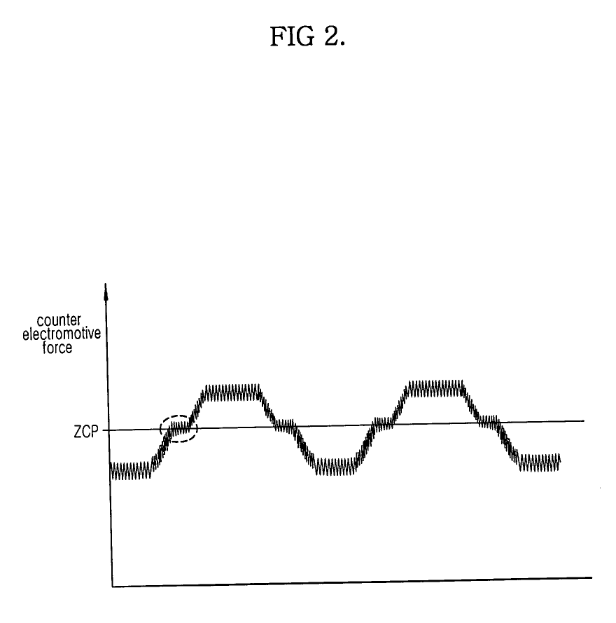

FIG. 3 is a graph illustrating an electric current's waveform in the conventional brushless DC motor;

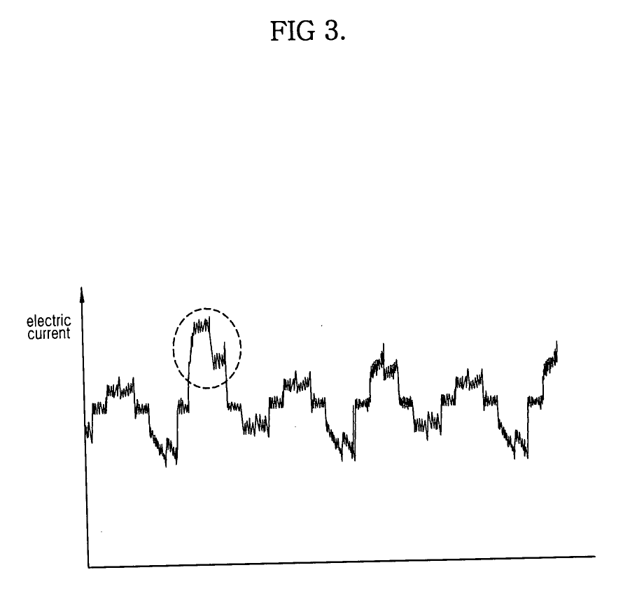

FIG. 4 is a plan view illustrating a brushless DC motor according to the present invention;

FIG. 5 is a graph illustrating a waveform of the counter electromotive force in the brushless DC motor according to the present invention; and

FIG. 6 is a graph illustrating a waveform of electric current in the brushless DC motor according to the present invention.

### DETAILED DESCRIPTION OF THE PREFERRED EMBODIMENTS

Reference will now be made in detail to the embodiments of the present invention, examples of which are illustrated in the accompanying drawings. The embodiments are described below to explain the present invention by referring to the figures.

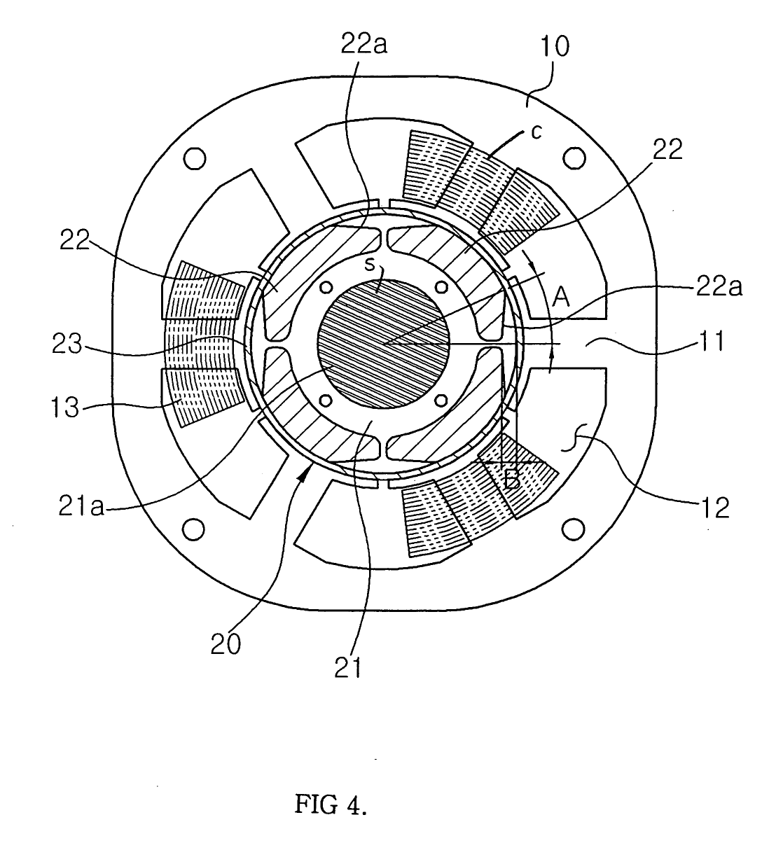

As shown in FIG. 4, a sensorless brushless DC motor according to the present invention includes a stator 10 and a rotor 20.

The rotor 20 is installed inside the stator 10, and for the installation of the rotor 20, a space for installing the rotor 20 is defined at the central portion of the stator 10. The stator 10 includes teeth 11 extended toward the central portion of the stator 10 and arranged in the radial direction, and slots 12 defined between adjacent teeth 11 around which coils are wound.

The rotor 20 is spaced apart from the teeth 11 of the stator 10 by a predetermined gap. The rotor 20 includes a core 21 disposed at the center of the stator 20 and in which a rotating shaft is mounted, magnets 22 arranged in the circumferential direction such that their polarities are alternately arranged, and a scatter preventing can 23 for preventing the magnets 22 from being separated from the rotor 20 due to the centrifugal force when the rotor 20 is rotated.

Meanwhile, the brushless DC motor according to the present invention is characterized in that each of the magnets 22 has chamfered portions 22a formed at outer ends sides thereof. Preferably, each circumferential length A of the chamfered portions 22a is about 22% to 33% of the overall circumferential length of one magnet 22, i.e. an angle with respect to the center of the rotor 20 is approximately 20 degrees to 30 degrees. Each radial length B of the chamfered portions 22a is preferably approximately 50% to 63% of the overall radial length of one magnet 22, i.e. approximately 4 mm to 5 mm when the thickness of one magnet 22 is 8 mm.

In the sensorless brushless DC motor according to the present invention, the voltage supplied to the stator 10 is controlled by detecting the position of the rotor 20 based on the phase counter electromotive forces present at the terminals of the coils of the stator 10.

In more detail, when the driving signal is applied, in order to position the rotor 20 at a predetermined position, the rotor 20 is arranged by supplying electric power to two phases of the stator 10. After that, if the motor is driven to rotate for a predetermined time and the motor exceeds predetermined RPMs (approximately more than 300 RPM), voltage is inducted to the coils of the stator 10 so as to generate the counter electromotive force. Then, the position of the rotor 20 is estimated based on the generated phase counter electromotive force, so that the driving signal can be generated and sensorless operation of the motor is enabled.

In estimating the position of the rotor 20, a controlling section (not shown) receives the counter electromotive forces of respective phases and detects the Vdc/2 point of the counter electromotive forces, i.e. the zero crossing point (ZCP), by using a comparator. When the rotor 20 is rotated over 30 degrees (electrical angle), the controlling section excites the next coil with electric current so as to drive the brushless DC motor.

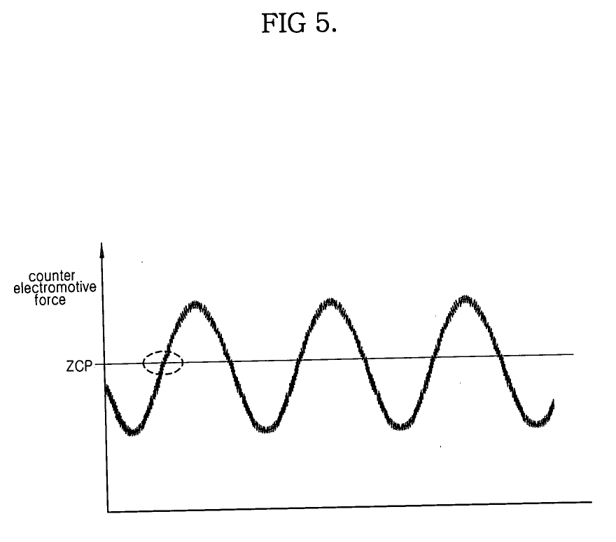

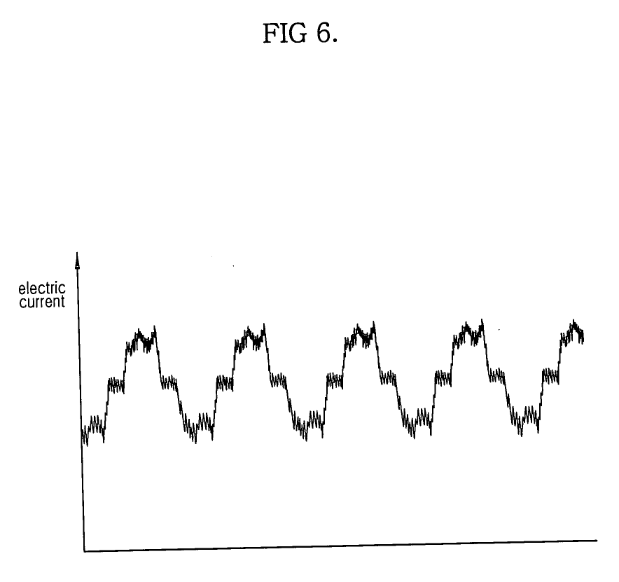

In the sensorless brushless DC motor, as shown in FIG. 5, since the ZCP is well-defined, the phase-changing point is also well-defined. As shown in FIG. 6, abnormal electric current waveforms do not appear.

The chamfered portions 22a of the magnets 22 mitigate the unbalance of the magnetic flux so as to decrease the cogging torque, and to soften vibration and noise.

As a result of testing a compressor adopting the sensorless brushless DC motor according to the present invention, the efficiency of the compressor was found to be enhanced by approximately 2% to 3%, and fluctuation when sucking and discharging was removed.

According to the brushless DC motor of the present invention, as described above, since the waveforms of the counter electromotive forces of respective phases generated at the coil terminals of the stator appear in the linear waveform at the ZCP, the position of the rotor is easily detected, and it is possible to prevent abnormal electric current from being generated.

Although a few embodiments of the present invention have been shown and described, it would be appreciated by those skilled in the art that changes may be made in this embodiment without departing from the principles and spirit of the invention, the scope of which is defined in the claims and their equivalents.

1. A brushless direct current motor comprising:
a stator including coils for inducing magnetic flux according to applied electric current; and
a rotor installed in the stator, and including a core in which a rotating shaft is connected, and four magnets attached around the core;
wherein each of the four magnets has chamfered portions at outer end sides thereof.

2. (canceled)

3. The brushless direct current motor according to claim 1, wherein the circumferential length of respective chamfered portions is approximately 22 to 33% of the overall circumferential length of the respective magnets.

4. The brushless direct current motor according to claim 1, wherein an angle of respective chamfered portions with respect to the center of the rotor is approximately 20 to 30 degrees.

5. The brushless direct current motor according to claim 1, wherein a radial length of respective chamfered portions is approximately 50 to 63% of the overall radial length of the respective magnets.

6. The brushless direct current motor according to claim 1 wherein said sides of adjacent magnets are disposed in immediate proximity to one another and have surfaces facing one another that are parallel.
